(19) United States
(12) Patent Application Publication
(10) Pub. No.: US 2026/0302098 A1
(43) Pub. Date: Oct. 1, 2026

(54) L-SHAPED KEY DEVICE

(71) Applicant: SUNREX TECHNOLOGY CORP., Taichung City (TW)

(72) Inventors: Yin CHU, Chongqing City (CN); Bao-Song MA, Chongqing City (CN); Shih-Pin LIN, Taichung City (TW)

(73) Assignee: SUNREX TECHNOLOGY CORP., Taichung City (TW)

(21) Appl. No.: 19/302,485

(22) Filed: Aug. 18, 2025

(30) Foreign Application Priority Data
Mar. 27, 2025 (TW) 114203064

(51) Int. Cl. H01H 13/14

(52) U.S. Cl. CPC H01H 13/14

(57) ABSTRACT

An L-shaped key device includes a base plate, a thin film circuit board disposed on the base plate, a resilient member disposed on the thin film circuit board, and a keycap disposed on the resilient member. A first linkage member is pivotally connected to the base plate and the keycap, and has a first hole and a second hole. A second linkage member is disposed in the first hole, is rotatable about a first axis, is T-shaped, and has a first linkage part pivotally connected to the keycap, and a second linkage part pivotally connected to the base plate. A third linkage member is disposed in the second hole, is rotatable about a second axis parallel with the first axis, and is pivotally connected to the base plate and the keycap.

### CROSS-REFERENCE TO RELATED APPLICATION

This application claims priority to Taiwanese Utility Model Patent Application No. 114203064, filed on Mar. 27, 2025, the entire disclosure of which is incorporated by reference herein.

### FIELD

The disclosure relates to an input device, and more particularly to an L-shaped key device.

### BACKGROUND

A conventional key device serving as an Enter key device for an English keyboard is L-shaped. The conventional key device includes a base plate, a thin film circuit board, a resilient member, a keycap, two scissor mechanisms, and two balancing strips. The base plate extends in a lengthwise direction. The thin film circuit board is disposed on the base plate. The resilient member is disposed on the thin film circuit board. The keycap extends in the lengthwise direction and is disposed above the resilient member. The two scissor mechanisms are disposed between the base plate and the keycap. The two balancing strips are disposed between the base plate and the keycap, and are adjacent to the scissor mechanisms.

By virtue of the two balancing strips, when the keycap is pressed, the keycap may remain horizontal and be stably moved downwardly. However, the two balancing strips may incur extra time for assembly and assembly costs of the conventional L-shaped key device may be increased. Pressing of the keycap may also produce noises due to the two balancing strips.

### SUMMARY

Therefore, an object of the disclosure is to provide an L-shaped key device that can alleviate at least one of the drawbacks of the prior art.

According to the disclosure, the L-shaped key device includes a base plate, a thin film circuit board, a resilient member, a keycap, and a scissor mechanism.

The base plate is elongated in a lengthwise direction and includes a plurality of first hooks, two second hooks, and two third hooks.

The thin film circuit board is elongated in the lengthwise direction and is disposed on the base plate.

The resilient member is disposed on a top film surface of the thin film circuit board that is opposite to the base plate, and extends upwardly.

The keycap is disposed on a top end of the resilient member, and has a keycap body plate, a surrounding wall, a plurality of first pivotal seats, two second pivotal seats, and two third pivotal seats. The keycap body plate is L-shaped and has a plate bottom surface facing the thin film circuit board. The surrounding wall extends downwardly from a periphery of the keycap body plate, and has a first end portion, a second end portion, a stepped side portion, and a straight side portion. The first end portion and the second end portion are spaced apart from each other in the lengthwise direction. The stepped side portion interconnects the first end portion and the second end portion, and has a first segment and a second segment that are respectively adjacent to the first end portion and the second end portion. The straight side portion is spaced apart from the stepped side portion and interconnects the first end portion and the second end portion. A distance between the first segment and the straight side portion in a direction transverse to the lengthwise direction is greater than a distance between the second segment and the straight side portion in the direction transverse to the lengthwise direction. The plurality of first pivotal seats are disposed on the plate bottom surface of the keycap body plate, and are adjacent to the straight side portion of the surrounding wall. The two second pivotal seats are disposed on the plate bottom surface of the keycap body plate, and are adjacent to the first segment of the surrounding wall. The two third pivotal seats are disposed on the plate bottom surface of the keycap body plate, and are adjacent to the second segment of the surrounding wall.

The scissor mechanism is disposed between the base plate and the keycap, and includes a first linkage member, a second linkage member, and a third linkage member. The first linkage member is elongated in the lengthwise direction and has a first linkage body, a central hole, a first hole, a second hole, two first linkage pivotal notches, and two second linkage pivotal notches. The first linkage body has a main top surface, a main bottom surface that is opposite to the main top surface, a first hook-engaging rod that is connected to the main top surface and the main bottom surface and that is pivotally engaged with the plurality of first hooks, and a first seat-engaging rod that is connected to the main top surface and the main bottom surface and that is pivotally engaged with the plurality of first pivotal seats. The central hole extends through the main top surface and the main bottom surface of the first linkage body. The resilient member extends through the central hole. The first hole extends through the main top surface and the main bottom surface of the first linkage body and is disposed on a side of the central hole. The second hole extends through the main top surface and the main bottom surface of the first linkage body and is disposed on an opposite side of the central hole. The two first linkage pivotal notches are in spatial communication with the first hole, and are aligned with each other along a first axis that extends in the lengthwise direction. The two second linkage pivotal notches are in spatial communication with the second hole, and are aligned with each other along a second axis that extends in the lengthwise direction and that is parallel to the first axis.

The second linkage member is disposed in the first hole, is rotatable about the first axis, is T-shaped, and has a first linkage part, a second linkage part, and two first pivotal shafts. The first linkage part has a second seat-engaging rod that is pivotally connected to the two second pivotal seats of the keycap. The second linkage part has a second hook-engaging rod that is pivotally connected to the two second hooks of the base plate. A maximum length of the first linkage part in the lengthwise direction is greater than a maximum length of the second linkage part in the lengthwise direction. The two first pivotal shafts are disposed on the second linkage part and are respectively inserted into the first linkage pivotal notches.

The third linkage member is disposed in the second hole, is rotatable about the second axis, and has a third seat-engaging rod, a third hook-engaging rod, and two second pivotal shafts. The third seat-engaging rod is pivotally connected to the two third pivotal seats of the keycap. The third hook-engaging rod is pivotally connected to the two third hooks of the base plate. The two second pivotal shafts are respectively inserted into the second linkage pivotal notches.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating an L-shaped key device according to an embodiment of the disclosure.

FIG. 2 is an exploded perspective view of the embodiment illustrating a base plate, a thin film circuit board, a resilient member, a keycap, and a scissor mechanism of the L-shaped key device.

FIG. 3 is an exploded perspective view of the embodiment illustrating the key cap, the resilient member, and the scissor mechanism.

FIG. 4 is a perspective view of the embodiment illustrating a first linkage member, a second linkage member, and a third linkage member of the scissor mechanism in an assembled state.

FIG. 5 is a top view from FIG. 4.

FIG. 6 is a sectional view taken along line VI-VI of FIG. 5.

FIG. 7 is an exploded perspective of the embodiment illustrating the scissor mechanism.

FIG. 8 is a schematic sectional view taken along line VIII-VIII of FIG. 1.

FIG. 9 is a schematic sectional view taken along line IX-IX of FIG. 1.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

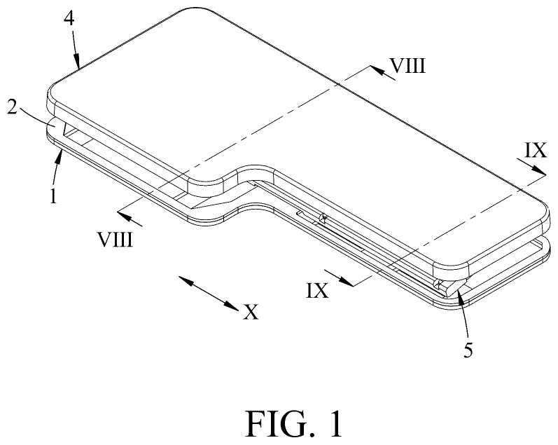

Referring to FIGS. 1, 2, and 3, an L-shaped key device according to an embodiment of the disclosure is suitable to serve as an Enter key device for an English keyboard. The L-shaped key device of the disclosure includes a base plate 1, a thin film circuit board 2, a resilient member 3, a keycap 4, and a scissor mechanism 5.

The base plate 1 is in an L-shaped and is elongated in a lengthwise direction (X). In this embodiment, the base plate 1 includes a base body 11, a plurality of first hooks 12 disposed on the base body 11, two second hooks 13 disposed on the base body 11, and two third hooks 14 disposed on the base body 11. The two second hooks 13 and the two third hooks 14 are situated at a side of the plurality of first hooks 12. The lengthwise direction (X) may be a front-rear direction.

The thin film circuit board 2 is L-shaped, is elongated in the lengthwise direction (X), and is disposed on the base body 11 of the base plate 1.

The resilient member 3 is disposed on a top film surface of the thin film circuit board 2 that is opposite to the base plate 1, and extends upwardly.

The keycap 4 is disposed on a top end of the resilient member 3, and includes a keycap body plate 41, a surrounding wall 42, a plurality of first pivotal seats 43, two second pivotal seats 44, and two third pivotal seats 45.

The keycap body plate 41 is L-shaped and has a plate bottom surface 411 facing the thin film circuit board 2.

The surrounding wall 42 extends downwardly from a periphery of the keycap body plate 41, and has a first end portion 421, a second end portion 422, a stepped side portion 423, and a straight side portion 424. The first end portion 421 and the second end portion 422 are spaced apart from each other in the lengthwise direction (X). The stepped side portion 423 interconnects the first end portion 421 and the second end portion 422, and has a first segment 425 and a second segment 426 that are respectively adjacent to the first end portion 421 and the second end portion 422. The straight side portion 424 is spaced apart from the stepped side portion 423 and interconnects the first end portion 421 and the second end portion 422. A distance between the first segment 425 and the straight side portion 424 in a direction transverse to the lengthwise direction (X) is greater than a distance between the second segment 426 and the straight side portion 424 in the direction transverse to the lengthwise direction (X).

The plurality of first pivotal seats 43 are disposed on the plate bottom surface 411 of the keycap body plate 41, and are adjacent to the straight side portion 424 of the surrounding wall 42.

The two second pivotal seats 44 are disposed on the plate bottom surface 411 of the keycap body plate 41, and are adjacent to the first segment 425 of the surrounding wall 42.

The two third pivotal seats 45 are disposed on the plate bottom surface 411 of the keycap body plate 41, and are adjacent to the second segment 426 of the surrounding wall 42.

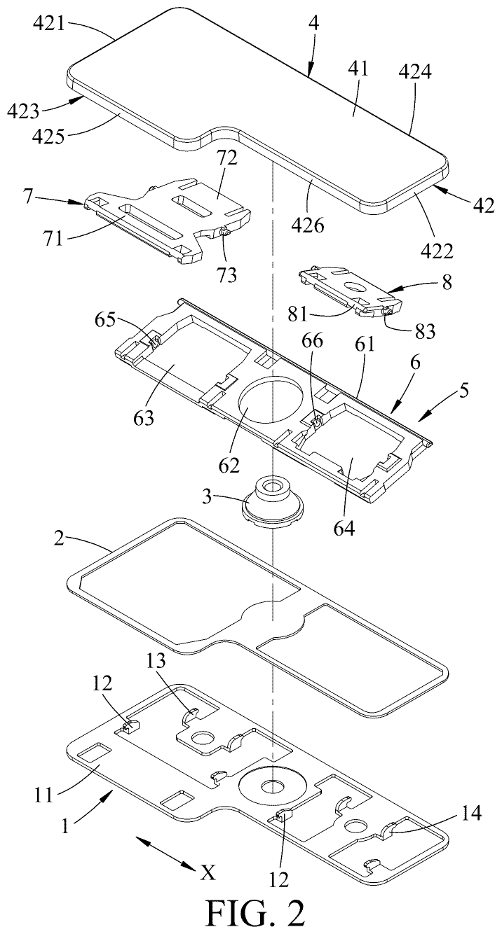

Referring to FIGS. 2, 3, and 4, the scissor mechanism 5 is disposed between the base plate 1 and the keycap 4, and includes a first linkage member 6, a second linkage member 7, and a third linkage member 8.

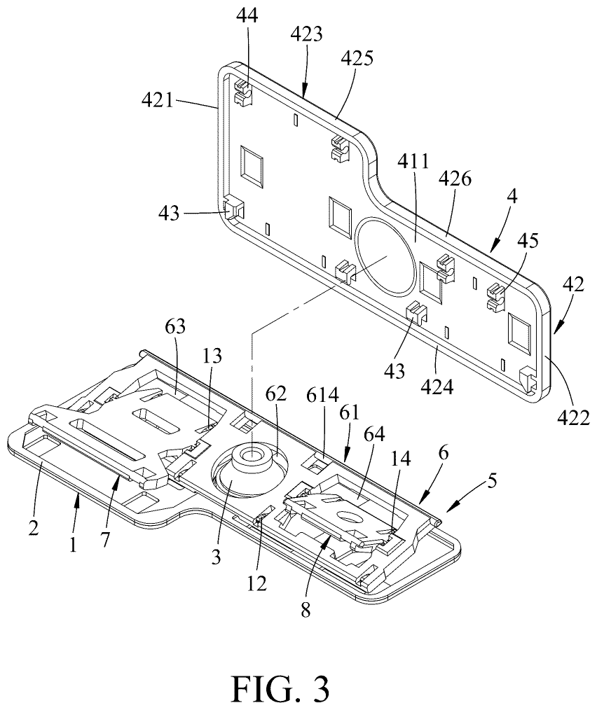

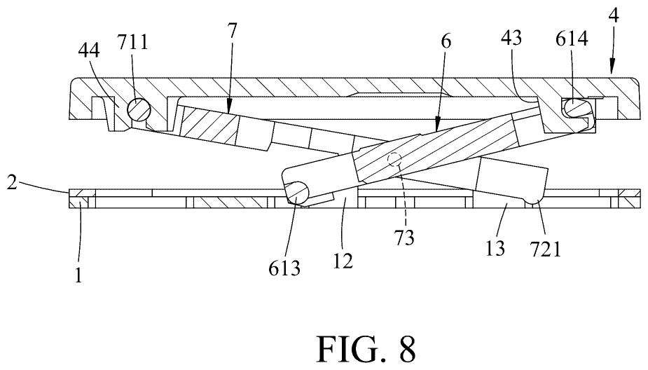

Referring to FIGS. 3, 4, and 7, the first linkage member 6 is rectangular, is elongated in the lengthwise direction (X), and has a first linkage body 61. The first linkage body 61 has a main top surface 611, a main bottom surface 612, a first hook-engaging rod 613, and a first seat-engaging rod 614. The main bottom surface 612 is opposite to the main top surface 611. The first hook-engaging rod 613 is connected to the main top surface 611 and the main bottom surface 612 and is pivotally engaged with the plurality of first hooks 12. The first seat-engaging rod 614 is connected to the main top surface 611 and the main bottom surface 612 and is pivotally engaged with the plurality of first pivotal seats 43. As shown in FIGS. 3 and 8, in this embodiment, the first hook-engaging rod 613 is rotatable relative to the plurality of first hooks 12. The first seat-engaging rod 614 is slidable relative to the plurality of first pivotal seats 43.

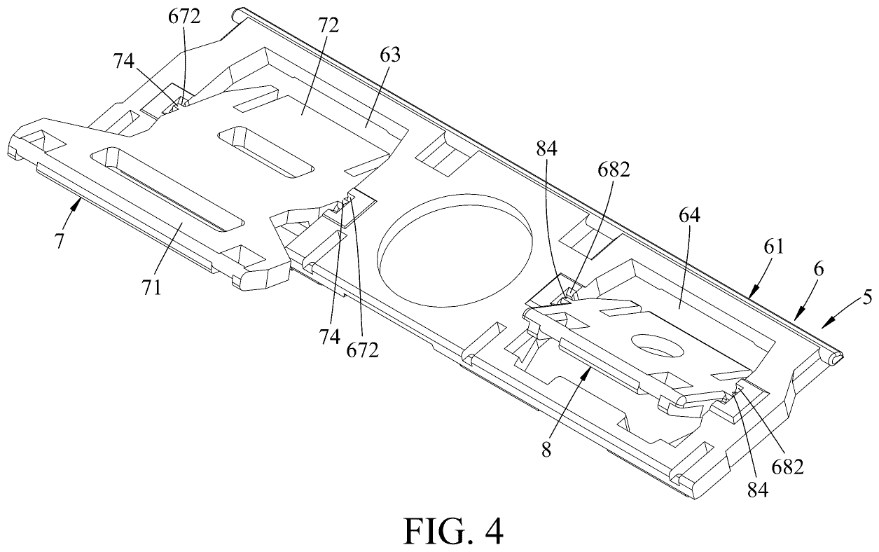

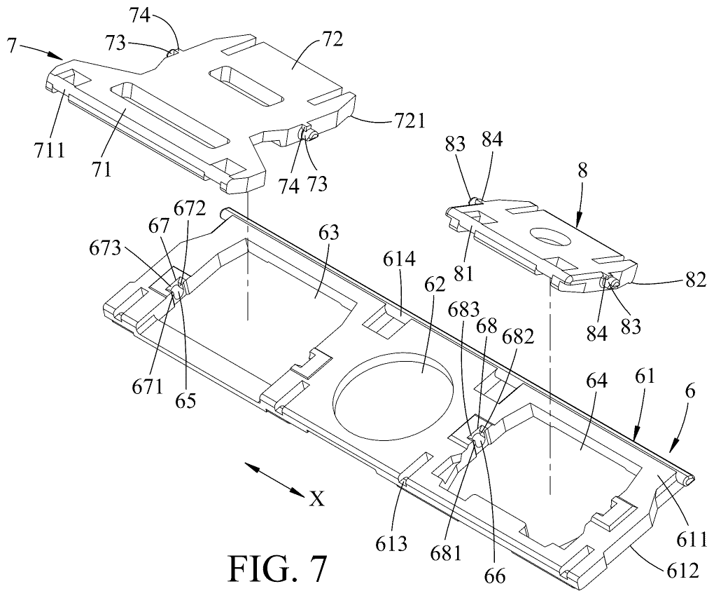

Referring back to FIGS. 4 and 7, the first linkage member 6 further has a central hole 62, a first hole 63, a second hole 64, two first linkage pivotal notches 65, two second linkage pivotal notches 66, two first limiting recesses 67, and two second limiting recesses 68.

The central hole 62 of the first linkage member 6 extends through the main top surface 611 and the main bottom surface 612 of the first linkage body 61. The resilient member 3 extends through the central hole 62.

The first hole 63 extends through the main top surface 611 and the main bottom surface 612 of the first linkage body 61 and is disposed on a side of the central hole 62.

The second hole 64 extends through the main top surface 611 and the main bottom surface 612 of the first linkage body 61 and is disposed on an opposite side of the central hole 62.

The two first linkage pivotal notches 65 are in spatial communication with the first hole 63, and are aligned with each other along a first axis (L1) that extends in the lengthwise direction (X).

The two second linkage pivotal notches 66 are in spatial communication with the second hole 64, and are aligned with each other along a second axis (L2) that extends in the lengthwise direction (X) and that is parallel to the first axis (L1).

The two first limiting recesses 67 are indented from the main top surface 611 toward the main bottom surface 612, and are respectively in direct connection with the two first linkage pivotal notches 65. Each of the first limiting recesses 67 is defined by two first limiting surfaces 671, 672 that are located respectively at opposite sides of the first axis (L1), and a first connecting surface 673 that interconnects and is transverse to the first limiting surfaces 671, 672.

The two second limiting recesses 68 are indented from the main top surface 611 toward the main bottom surface 612, and are respectively in direct connection with the two second linkage pivotal notches 66. Each of the second limiting recesses 68 is defined by two second limiting surfaces 681, 682 that are located respectively at opposite sides of the second axis (L2), and a second connecting surface 683 that interconnects and is transverse to the second limiting surfaces 681, 682.

As shown in FIGS. 3, 5, and 7, the second linkage member 7 is disposed in the first hole 63, is rotatable about the first axis (L1), is T-shaped, and has a first linkage part 71, a second linkage part 72, two first pivotal shafts 73, and two first limiting blocks 74.

The first linkage part 71 has a second seat-engaging rod 711 that is pivotally connected to the two second pivotal seats 44 of the keycap 4.

The second linkage part 72 has a second hook-engaging rod 721 that is pivotally connected to the two second hooks 13 of the base plate 1. A maximum length of the first linkage part 71 in the lengthwise direction (X) is greater than a maximum length of the second linkage part 72 in the lengthwise direction (X).

The two first pivotal shafts 73 are disposed on the second linkage part 72 and are respectively inserted into the first linkage pivotal notches 65.

The two first limiting blocks 74 are respectively disposed on top ends of the first pivotal shafts 73, and respectively extend into the first limiting recesses 67.

In this embodiment, as shown in FIGS. 2, 3, and 8, the second seat-engaging rod 711 of the first linkage part 71 is rotatable relative to the two second pivotal seats 44 of the keycap 4. The second hook-engaging rod 721 of the second linkage part 72 is slidable relative to the two second hooks 13 of the base plate 1.

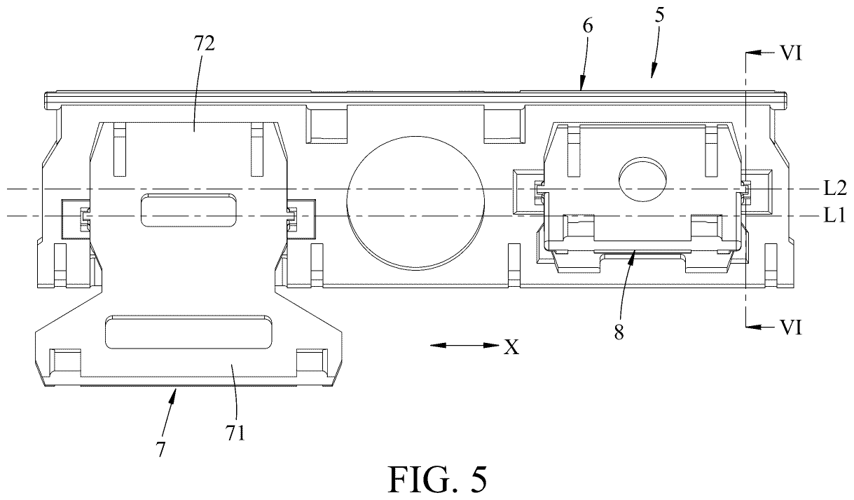

Referring back to FIGS. 4 and 5, the third linkage member 8 is disposed in the second hole 64, and is rotatable about the second axis (L2). With reference back to FIGS. 3 and 7, the third linkage member 8 has a third seat-engaging rod 81, a third hook-engaging rod 82, two second pivotal shafts 83, and two second limiting blocks 84.

The third seat-engaging rod 81 is pivotally connected to the two third pivotal seats 45 of the keycap 4.

The third hook-engaging rod 82 is pivotally connected to the two third hooks 14 of the base plate 1.

The two second pivotal shafts 83 are respectively inserted into the second linkage pivotal notches 66.

The two second limiting blocks 84 are respectively disposed on top ends of the second pivotal shafts 83, and respectively extend into the second limiting recesses 68.

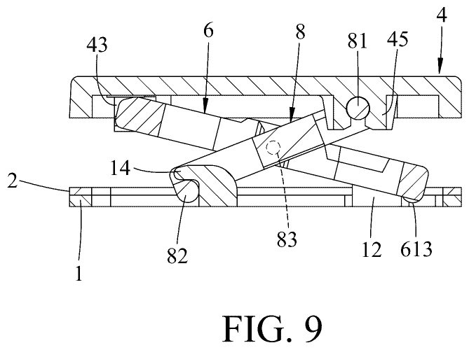

As shown in FIGS. 3 and 9, the third seat-engaging rod 81 is rotatable relative to the two third pivotal seats 45 of the keycap 4. The third hook-engaging rod 82 is slidable relative to the two third hooks 14 of the base plate 1.

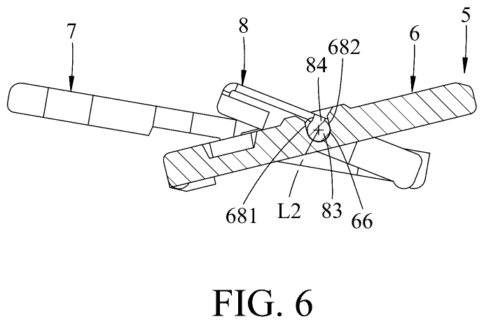

As shown in FIGS. 1, 8, and 9, when a user presses the keycap 4, because the scissor mechanism 5 is disposed between the base plate 1 and the keycap 4, the keycap 4 remains horizontal and is moved stably toward the thin film circuit board 2. Specifically, as shown in FIGS. 7 and 8, as the keycap 4 is pressed, the first hook-engaging rod 613 is rotated relative to base plate 1, the first seat-engaging rod 614 is slid relative to the keycap 4 in the direction transverse to the lengthwise direction (X), the second seat-engaging rod 711 of the first linkage part 71 of the second linkage member 7 is rotated relative to the keycap 4, and the second hook-engaging rod 721 of the second linkage part 72 of the second linkage member 7 is slid relative to the base plate 1 in the direction transverse to the lengthwise direction (X). By virtue of the two first pivotal shafts 73 of the linkage member 7 being respectively inserted into the first linkage pivotal notches 65 of the first linkage member 6, the second linkage member 7 and the first linkage member 6 are rotated relative to each other. By virtue of each of the two first limiting blocks 74 cooperating with the two first limiting surfaces 671, 672 defining a respective one of the first limiting recesses 67, a rotational angle between the second linkage member 7 and the first linkage member 6 may be controlled so as to prevent an excessive rotational angle between the second linkage member 7 and the first linkage member 6 from causing the second hook-engaging rod 721 of the second linkage member 7 to be disconnected from the two second hooks 13 of the base plate 1 and from causing the first seat-engaging rod 614 of the first linkage member 6 to be disengaged from the plurality of first pivotal seats 43 of the keycap 4. At the same time, as shown in FIGS. 6, 7, and 9, the third seat-engaging rod 81 of the third linkage member 8 is rotated relative to the keycap 4, and the third hook-engaging rod 82 of the third linkage member 8 is slid relative to the base plate 1 in the direction transverse to the lengthwise direction (X). By virtue of the two second pivotal shafts 83 of the third linkage member 8 being respectively inserted into the second linkage pivotal notches 66 of the first linkage member 6, the third linkage member 8 and the first linkage member 6 are rotated relative to each other. By virtue of each of the two second limiting blocks 84 cooperating with the two second limiting surfaces 681, 682 defining a respective one of the second limiting recesses 68, a rotational angle between the third linkage member 8 and the first linkage member 6 may be controlled so as to prevent an excessive rotational angle between the third linkage member 8 and the first linkage member 6 from causing the third hook-engaging rod 82 of the third linkage member 8 to be disconnected from the two third hooks 14 of the base plate 1 and from causing the first seat-engaging rod 614 of the first linkage member 6 to be disengaged from the plurality of first pivotal seats 43 of the keycap 4.

The L-shaped key device of the disclosure has the following advantages.
1. By virtue of the structures of the first linkage member 6, the second linkage member 7, and the third linkage member 8 of the scissor mechanism 5 disposed between the base plate 1 and the keycap 4, the keycap 4 that is pressed remains horizontal and is moved toward the thin film circuit board 2. Without balancing strips, assembly time and assembly costs of the L-shaped key device of the disclosure may be reduced, and pressing of the keycap 4 is unlikely to produce noises.
2. Because the excessive rotational angle between the second linkage member 7 and the first linkage member 6 and the excessive rotational angle between the third linkage member 8 and the first linkage member 6 are eliminated, malfunction of the L-shaped key device of the disclosure is less likely to happen.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An L-shaped key device comprising:
a base plate being elongated in a lengthwise direction and including a plurality of first hooks, two second hooks, and two third hooks;
a thin film circuit board being elongated in the lengthwise direction and disposed on said base plate;
a resilient member disposed on a top film surface of said thin film circuit board that is opposite to said base plate, and extending upwardly;
a keycap disposed on a top end of said resilient member, and having
a keycap body plate that is L-shaped and that has a plate bottom surface facing said thin film circuit board,
a surrounding wall that extends downwardly from a periphery of said keycap body plate, and that has
a first end portion and a second end portion spaced apart from each other in the lengthwise direction,
a stepped side portion interconnecting said first end portion and said second end portion, and having a first segment and a second segment that are respectively adjacent to said first end portion and said second end portion, and
a straight side portion spaced apart from said stepped side portion and interconnecting said first end portion and said second end portion, a distance between said first segment and said straight side portion in a direction transverse to the lengthwise direction being greater than a distance between said second segment and said straight side portion in the direction transverse to the lengthwise direction,
a plurality of first pivotal seats that are disposed on said plate bottom surface of said keycap body plate, and that are adjacent to said straight side portion of said surrounding wall,
two second pivotal seats that are disposed on said plate bottom surface of said keycap body plate, and that are adjacent to said first segment of said surrounding wall, and
two third pivotal seats that are disposed on said plate bottom surface of said keycap body plate, and that are adjacent to said second segment of said surrounding wall; and
a scissor mechanism disposed between said base plate and said keycap, and including
a first linkage member that is elongated in the lengthwise direction and that has
a first linkage body having a main top surface, a main bottom surface that is opposite to said main top surface, a first hook-engaging rod that is connected to said main top surface and said main bottom surface and that is pivotally engaged with said plurality of first hooks, and a first seat-engaging rod that is connected to said main top surface and said main bottom surface and that is pivotally engaged with said plurality of first pivotal seats,
a central hole extending through said main top surface and said main bottom surface of said first linkage body, said resilient member extending through said central hole,
a first hole extending through said main top surface and said main bottom surface of said first linkage body and disposed on a side of said central hole,
a second hole extending through said main top surface and said main bottom surface of said first linkage body and disposed on an opposite side of said central hole,
two first linkage pivotal notches being in spatial communication with said first hole, and aligned with each other along a first axis that extends in the lengthwise direction, and
two second linkage pivotal notches being in spatial communication with said second hole, and aligned with each other along a second axis that extends in the lengthwise direction and that is parallel to the first axis,
a second linkage member that is disposed in said first hole, that is rotatable about the first axis, that is T-shaped, and that has
a first linkage part having a second seat-engaging rod that is pivotally connected to said two second pivotal seats of said keycap,
a second linkage part having a second hook-engaging rod that is pivotally connected to said two second hooks of said base plate, a maximum length of said first linkage part in the lengthwise direction being greater than a maximum length of said second linkage part in the lengthwise direction, and
two first pivotal shafts disposed on said second linkage part and respectively inserted into said first linkage pivotal notches, and
a third linkage member that is disposed in said second hole, that is rotatable about the second axis, and that has
a third seat-engaging rod pivotally connected to said two third pivotal seats of said keycap,
a third hook-engaging rod pivotally connected to said two third hooks of said base plate, and
two second pivotal shafts respectively inserted into said second linkage pivotal notches.

2. The L-shaped key device as claimed in claim 1, wherein:
said first linkage member further has two first limiting recesses that are indented from said main top surface toward said main bottom surface, and that are respectively in direct connection with said two first linkage pivotal notches;
each of said first limiting recesses is defined by
two first limiting surfaces that are located respectively at opposite sides of the first axis, and
a first connecting surface that interconnects and is transverse to said first limiting surfaces; and
said second linkage member further has two first limiting blocks that are respectively disposed on top ends of said first pivotal shafts, and that respectively extend into said first limiting recesses.

3. The L-shaped key device as claimed in claim 1, wherein:
said first linkage member further has two second limiting recesses that are indented from said main top surface toward said main bottom surface, and that are respectively in direct connection with said two second linkage pivotal notches;
each of said second limiting recesses is defined by
two second limiting surfaces that are located respectively at opposite sides of the second axis, and
a second connecting surface that interconnects and is transverse to said second limiting surfaces; and
said third linkage member further has two second limiting blocks that are respectively disposed on top ends of said second pivotal shafts, and that respectively extend into said second limiting recesses.

4. The L-shaped key device as claimed in claim 2, wherein:
said first linkage member further has two second limiting recesses that are indented from said main top surface toward said main bottom surface, and that are respectively in direct connection with said two second linkage pivotal notches;
each of said second limiting recesses is defined by
two second limiting surfaces that are located respectively at opposite sides of the second axis, and
a second connecting surface that interconnects and is transverse to said second limiting surfaces; and
said third linkage member further has two second limiting blocks that are respectively disposed on top ends of said second pivotal shafts, and that respectively extend into said second limiting recesses.
